(19) United States
(12) Patent Application Publication
(10) Pub. No.: US 2017/0122526 A1
(43) Pub. Date: May 4, 2017

(54) A LENS AND AN ILLUMINATION DEVICE INCLUDING THE LENS

(71) Applicant: OSRAM GmbH, Munich (DE)

(72) Inventor: Aiai Li, Shenzhen (CN)

(21) Appl. No.: 15/317,135

(22) PCT Filed: Jun. 3, 2015
(86) PCT No.: PCT/EP2015/062455

§ 371 Date: Dec. 8, 2016

(30) Foreign Application Priority Data
Jul. 18, 2014 (CN) 201410345230.1

(51) Int. Cl. F21V 5/04; F21V 5/00

(52) U.S. Cl. CPC F21V 5/046; F21V 5/002; F21Y 2115/10

(57) ABSTRACT

Various embodiments relate to a lens for an illumination device and an illumination device including the lens, wherein the lens has an incident surface and an exiting surface, and the lens is designed in rotation symmetry, wherein, the incident surface includes a central recessed portion which is recessed towards the exiting surface and through which the rotation axis of the lens passes and a circumferential protrusion portion which protrudes in a direction away from the exiting surface and encompasses the central recessed portion.

### RELATED APPLICATIONS

The present application is a national stage entry according to 35 U.S.C. §371 of PCT application No.: PCT/EP2015/062455 filed on Jun. 3, 2015, which claims priority from Chinese application No.: 201410345230.1 filed on Jul. 18, 2014, and is incorporated herein by reference in its entirety.

### TECHNICAL FIELD

Various embodiments relate to a lens for an illumination device and an illumination device including this lens.

### BACKGROUND

In order to adjust the light intensity distribution which can be formed by the exiting light of an illumination device and the color temperature distribution which can be obtained from the exiting light of the illumination device, a lens for a light source is provided in the illumination device. The lens in the illumination device can regulate, for instance, in a refractive or reflective manner, the illumination direction of the light from the light source passing through the lens, so as to adjust the distribution of light emitted from the illumination device.

In a commonly used LED illumination device, a coating layer is used in many illumination devices such that exiting light can be re-mixed with the help of the coating layer to achieve a desired uniform light distribution. However, these illumination devices still have the problem of non-uniformity of color temperature distribution or light intensity distribution to some extent, especially in the case of illumination devices with a small beam angle design. This type of the illumination devices addresses the problem of non-uniformity of color temperature distribution by, for example, applying a scattering layer on a surface of a TIR lens module. Nevertheless, due to influence of reflection of light at sides of the lens, such design may reduce the uniformity of the light intensity distribution of the exiting light, the distribution of light projected by the illumination device on the light box is brighter at edges, and the color deviation is bigger.

### SUMMARY

Various embodiments provide a lens for an illumination device and an illumination device including such lens. With the use of this lens, not only the color temperature uniformity of the exiting light from the illumination device can be improved, but also the uniformity of the light intensity distribution can be improved.

A lens for an illumination device may have an incident surface and an exiting surface, and the lens is designed in rotation symmetry, wherein, the incident surface includes a central recessed portion which is recessed towards the exiting surface and through which the rotation axis of the lens passes, and a circumferential protrusion portion which protrudes in a direction away from the exiting surface and encompasses the central recessed portion. According to various embodiments, the incident light can be converged in a manner of deviating from the rotation axis such that the lens can reduce the luminous flux of the incident light projected to the central area of the exiting surface opposite to the light source, and comparatively increase the luminous flux of the incident light projected to the rest area of the exiting surface opposite to the light source, which improves distribution uniformity of incident light on the exiting surface.

According to various embodiments, the incident surface is formed in a manner of rotating a curve around the rotation axis. According to the design of the present disclosure, the curve is bent in a direction towards the light source, wherein the resulted incident surface provides a simple optical structure and it is easy to manufacture and machine such a lens.

According to various embodiments, the curve is configured as a spline. To configure the curve forming the cross section of the lens as a spline simplifies the process of designing the lens and can reduce the manufacture cost of the lens.

In various embodiments, the exiting surface is configured so that light exiting through the exiting surface is at least partially mixed after exiting through the exiting surface. The light treated by the incident surface can form beam sources to be mixed which has a predetermined light intensity distribution when exiting. These beam sources are mixed upon secondary processing of the exiting surface such that beams, e.g. close to the center area of the rotation axis, can be mixed with beams in other areas, so as to provide the possibility of improving the light intensity distribution and color temperature distribution of the exiting light.

Advantageously for the present disclosure, the exiting surface is configured as a scattering surface. The exiting surface as a scattering surface is integrated with a function of blending the incident light prior to exiting.

Advantageously, the exiting surface is coated with a scattering coating. A simple manner of processing the exiting surface is provided by coating the scattering coating on the exiting surface, and a favorable condition is provided for blending the exiting light.

According to various embodiments, the lens further includes a receiving portion configured to receive the light source of the illumination device, wherein the surface of the receiving portion which faces the light source is formed as the incident surface. The receiving portion may be configured to have side walls which can transmit light. A first part of the light from the light source may then be refracted by the incident surface and exits through the exiting surface, while a second part of the light from the light source can then pass the side walls of the receiving portion and reach the inner wall of the lens, and upon reflection by the inner wall, the light exits through the exiting surface of the lens. The exiting light from the first part of the light and the second part of the light may then be mixed up with each other after exiting, which improves the color uniformity and luminance uniformity.

Furthermore, an illumination device may include a light source and the lens as described above for receiving the light source. The illumination device according to various embodiments may achieve a more uniform light intensity distribution and color temperature distribution of the exiting light.

In various embodiments, the light source of this illumination device is configured to include an LED. An LED chip has the advantages such as high efficiency and energy saving, and can be used as a light source to output light strong enough to the lens.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic diagram of a cross section of a lens, through which an rotation axis extends and passes, according to an example of the present disclosure;

FIG. 2 shows a schematic diagram of color temperature distribution of exiting light treated by the lens according to an example of the present disclosure; and

FIG. 3 shows a schematic diagram of distribution of luminous flux treated by the lens according to an example of the present disclosure.

### DETAILED DESCRIPTION

In the following detailed description, reference is made to the accompanying drawings, which form a part hereof, and in which is shown by way of illustration specific embodiments in which various embodiments may be practiced. In this regard, directional terminology, such as “left”, “right”, is used in reference to the orientation of the figures being described. Because components of embodiments of the present disclosure can be positioned in a number of different orientations, the directional terminology is used for purposes of illustration and is in no way limiting. It is to be understood that other embodiments may be utilized and structural or logical changes may made without departing from the scope of the present disclosure. The following detailed description, therefore, is not to be taken in a limiting sense, and the scope of the present disclosure is defined by the appended claims.

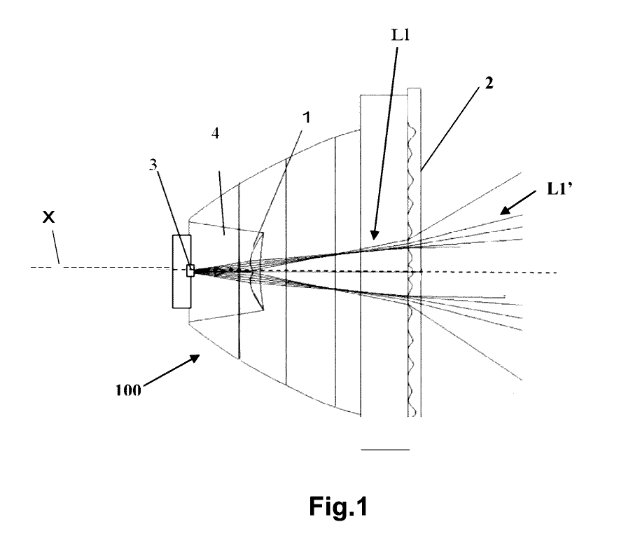

FIG. 1 shows a schematic diagram of a cross section of a lens 100, through which a rotation axis X extends and passes, according to an example of the present disclosure. Herein, in the present disclosure, the rotation axis X may coincide with the optical axis of the lens 100. The lens 100 as shown in FIG. 1 may be configured symmetrical relative to the rotation axis X. A light source 3 is located on the left to the lens 100. The lens 100 includes a receiving portion 4, an incident surface 1, and an exiting surface 2. The receiving portion 4 is configured to receive the light source 3 and configured in a shape of cavity. The incident surface 1 is configured at one side of the receiving portion 4 opposite to the light source 3, wherein the incident surface 1 is provided on the right relative to the light source 3 as shown in FIG. 1. The exiting surface 2 is configured downstream of an optical path of light of the light source 3, i.e., on the right relative to the incident surface 1 as shown in FIG. 1. The light from the light source 3, processed by the incident surface 1, exits through the exiting surface 2. The light source 3 may be configured to include an LED chip provided on an electrical carrier through a surface mounting technique, and the electrical carrier provided with the LED chip may be configured to be at least partially received in the receiving portion 4.

As shown in FIG. 1, the incident surface 1 according to various embodiments is configured to be formed in a manner of rotating a curve around the rotation axis X, thereby, this incident surface 1 is rotationally symmetrical relative to the rotation axis X. As viewed from the cross section through which the rotation axis X extends and passes, this incident surface 1 has two curves symmetrical relative to the rotation axis X, and respective curve protrudes towards the light source 3. The curves may be designed as a spline, respectively. In other words, a central recessed portion which sinks or is recessed away from the light source 3 is formed at a center of the incident surface 1 of the lens 100 according to the present disclosure. As a result, the incident light enters through the protruded areas of the incident surface 1, i.e. the circumferential protrusion portion which encompasses the central recessed portion can be converged as being deviated from the rotation axis X, such that the lens 100 can reduce the luminous flux of incident light in the central area of the exiting surface.

As shown in FIG. 1, a central recessed portion recessed relative to protrusions of the incident surface 1 is formed as the splines intersect. The light from the light source 3 passes through the curved portions of the incident surface 1, and the protruding structures of the curved portions refract and converge the light passing through these structures, in such way, incident light L1 is formed. Here, regardless that it is only shown in FIG. 1 the entered light upon being processed by the incident surface 1, it is understood that the light entering the lens 100 further includes for example the light entered through the side walls of the receiving portion 4, which can be reflected inside the lens, and reaches the exiting surface 2 and exits. As viewed from the cross section as shown in FIG. 1, since the incident surface 1 is configured symmetrical relative to the rotation axis X, a part of light from the light source 1, after being processed by the incident surface 1, forms incident light L1 above and below the rotation axis X as shown in the figure symmetrical relative to the rotation axis X. The incident light L1 can be converged to form a focus after passing through the incident surface 1 prior to exiting. But according to practical circumstances, the incident surface 1 also can be configured to selectively allow the incident light L1 not to converge to form the focus before exiting.

Besides, the exiting surface 2 is configured as a scattering surface or coated with a scattering coating. The incident light L1 which is formed as the light of the light source 3 passes through different portions of the incident surface 1 may be, for instance, scattered, when exiting through the exiting surface 2. The incident light L1 forms exiting light L1′ after being scattered by and exiting through the exiting surface 2. Under the action of secondary optical processing of the exiting surface 2, the exiting light L1′ can carry out at least partial mixing with the other exited light. Accordingly, for example, as shown in FIG. 1, the exiting light L1′ can mix with the light exiting from the other regions of the exiting surface 2, thereby, on the basis of the primary processing of the incident surface 1 and the secondary processing of the exiting surface 2, the exiting light L1′ can mix in a predetermined manner in different areas. Based on the above-mentioned optical treatment processes, the exiting light treated by the lens 100 has improved light intensity distribution and color temperature distribution, especially in areas close to the rotation axis X.

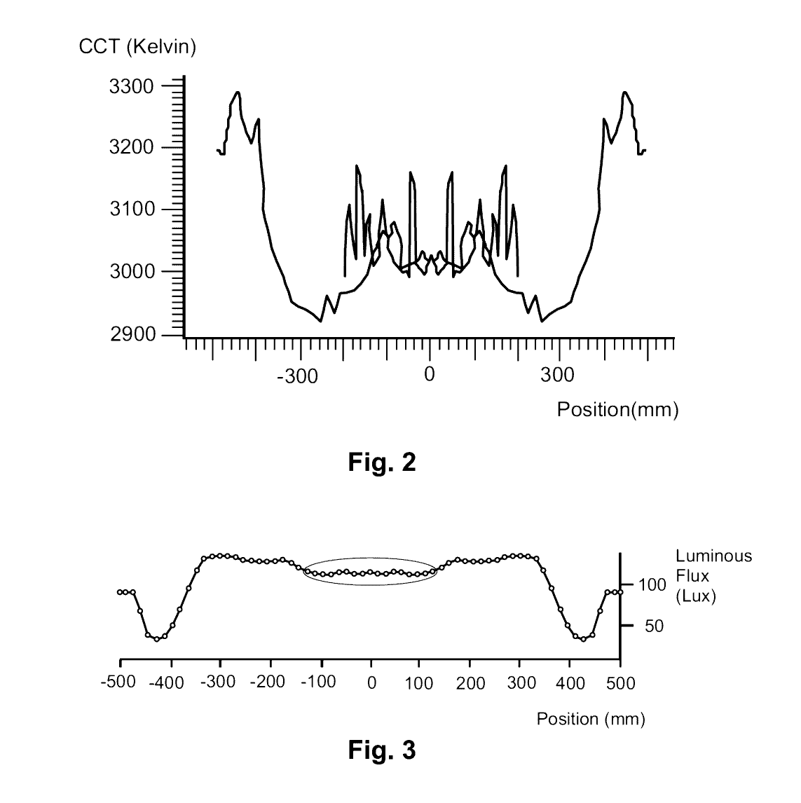

FIG. 2 shows a schematic diagram of color temperature distribution of exiting light processed by the lens 100 according to an embodiment of the present disclosure, and FIG. 3 shows a schematic diagram of distribution of luminous flux processed by the lens 100 according to an embodiment of the present disclosure. The light distribution formed by the light exiting from the lens 100 according to the present disclosure has improved color temperature distribution at places close to a light spot, and the color temperature distribution at these places becomes more uniform. Besides, the light distribution formed has improved light intensity distribution in the center area of the light spot, and the light intensity distribution at this place also becomes more uniform, for instance, in the place indicated by a solid line as shown in FIG. 3, the light intensity distribution at this placed obtained according to the present disclosure is more uniform than the light intensity obtained by a conventional lens.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lens for an illumination device, comprising an incident surface and an exiting surface, the lens being designed in rotation symmetry, wherein the incident surface comprises a central recessed portion which is recessed towards the exiting surface and through which the rotation axis (X) of the lens passes and a circumferential protrusion portion which protrudes in a direction away from the exiting surface and encompasses the central recessed portion.

2. The lens according to claim 1, wherein the incident surface is formed in a manner of rotating a curve around the rotation axis (X).

3. The lens according to claim 2, wherein the curve is configured as a spline.

4. The lens according to claim 1, wherein the exiting surface is configured so that light exiting through the exiting surface is at least partially mixed after exiting through the exiting surface.

5. The lens according to claim 1, wherein the exiting surface is configured as a scattering surface.

6. The lens according to claim 1, wherein the exiting surface is coated with a scattering coating.

7. The lens according to claim 1, further comprising a receiving portion configured to receive a light source of the illumination device, wherein the surface of the receiving portion which faces the light source is formed as the incident surface.

8. An illumination device comprising a light source and a lens for receiving the light source, the lens comprising an incident surface and an exiting surface, the lens being designed in rotation symmetry, wherein the incident surface comprises a central recessed portion which is recessed towards the exiting surface and through which the rotation axis (X) of the lens passes and a circumferential protrusion portion which protrudes in a direction away from the exiting surface and encompasses the central recessed portion.

9. The illumination device according to claim 8, wherein the light source is configured to comprise an LED.
